(19) United States
(12) Patent Application Publication
(10) Pub. No.: US 2009/0096177 A1
(43) Pub. Date: Apr. 16, 2009

(54) METHOD OF HOLDING EASILY DEFORMED WORKPIECES AND CHUCK FOR CARRYING OUT THE METHOD

(76) Inventor: Georg Rohm, Sosntheim (DE)

Correspondence Address: K.F. ROSS P.C., 5683 RIVERDALE AVENUE, SUITE 203 BOX 900, BRONX, NY, 10471-0900, US

(21) Appl. No.: 12/111,296

(22) Filed: Apr. 29, 2008

(30) Foreign Application Priority Data
Oct. 16, 2007 (DE) PCT/DE2007/001835

(51) Int. Cl. B23B 5/22; B23B 5/34

(52) U.S. Cl. 279/121; 279/60

(57) ABSTRACT

The invention relates to a method of chucking easily deformed workpieces (6) sensitive to deformation, particularly thin-walled rings, wherein the workpiece (6) to be chucked is placed between the jaws (2) of a chuck (1) comprising a pole block (7) having at least one magnet (4) in a chuck body (3) behind the jaws, and wherein the workpiece is centered by closing the jaws (2) and fixed in this centered position by the magnet (4). The invention further relates to a chuck (1) comprising a magnet (4) provided in a pole block (7) behind the jaws (2).

### CROSS REFERENCE TO RELATED APPLICATIONS

This application is the US national phase of PCT application PCT/DE2007/001835, filed 16 Oct. 2007, whose entire disclosure is herewith incorporated by reference.

The invention relates to a method of chucking easily deformed workpieces, particularly thin-walled rings, where the workpiece to be chucked is placed between the jaws of a chuck comprising a pole block having at least one magnet in the chuck body thereof behind the jaws, and wherein the workpiece is centered by closing the jaws and fixed in this centered position by the magnet. The invention also relates to a chuck for carrying out the method.

It is known from the prior art and has been described, for example, in DE 299 04 532, to chuck easily deformed workpieces by means of a chuck for workpieces in order to machine the workpieces, the device using magnets. However, this is associated with the disadvantage that workpieces having a small support surface are subject to insufficient retaining forces, these problems in principle being the result of the properties of thin-walled rings like those required as bearing rings having a diameter in the range from about 250 to 5,000 mm. In addition, there is the possibility that the workpieces are displaced by the forces occurring during machining; furthermore, the magnets do not provide centered clamping, so that the correct alignment of the workpieces prior to performing the machining operation is very time-consuming.

It is therefore the object of the invention to provide a method that avoids the above-described disadvantages. It is a further object of the invention to provide a chuck that can be used to carry out the inventive method.

The object relating to the method is attained by the method described above, which takes advantage of the fact that centered chucking can be achieved by the chuck without added effort, so that prior to starting the machining operation of the workpiece the correct alignment thereof is easily guaranteed. Furthermore, as a result of using the chuck, the forces occurring during machining also cannot displace the workpiece because it is positively fixed by the jaws of the chuck. It should be noted with respect to the inventive method that, contrary to the conventional use, the chuck is not necessarily used to chuck the workpiece sensitive to deformation, however that such supportive use is of course possible, in that a clamping force is produced during the closing motion of the jaws serving centering purposes.

According to the invention, it is also preferred that, after closing the jaws, the magnet configured as a solenoid is activated, so that the centering of the workpiece can be carried out by the jaws without interfering interaction by a permanent magnet.

According to the invention, it is also possible to increase the field strength of the solenoid as a function of the rotational speed for the at least partial compensation for centrifugal-force induced loss of clamping force of the jaws, so as to reliably secure the position of the workpiece. Of course it is also possible to increase the clamping force as a function of the rotational speed for the at least partial compensation for the centrifugal-force induced loss of clamping force of the jaws.

Contrary to the device according to DE 299 04 532, machining of the workpiece is only possible on two surfaces when using the chuck, because the third surface is blocked by the jaws. Therefore, it is provided according to the invention to disengage the jaws from the workpiece after machining the two free surfaces thereof and bring about the fixation thereof solely by the solenoid, in order to prevent the disadvantages associated with the presence of the jaws.

In order to counteract shifting of the workpiece, according to the inventive method the field strength of the solenoid is increased after disengaging the jaws.

The object relating to the device is attained by a chuck, which can be configured to be manually or power-operated, and which is characterized in that it comprises a plurality of jaws guided radially on a chuck body, and in that a pole block having at least one solenoid is provided in the chuck body behind the jaws. The integration of the pole block having a solenoid within a chuck, the basic design of which is known from the prior art, offers the possibility of maintaining precisely the basic design of the chuck, and particularly that it is not impaired by the adjustability of the jaws by the pole block built into it behind the jaws.

Furthermore, it is particularly preferred to provide an electric coil of the solenoid or electric coils of a plurality of solenoids between the jaws in the magnetic regions such that adjacent magnetic regions have different magnetic poles. With this arrangement, high field strength can be achieved with low design effort. Furthermore, it is advantageous to provide six jaws and six magnetic regions, because this produces an appropriate compromise between the complexity of the apparatus and evenly applied forces on the easily deformed workpieces in the circumferential direction.

Furthermore, it is advantageous to provide each magnetic region with regions having different poles by separating them in the middle, because in this way it is also possible to use any arbitrary, even uneven, number of jaws.

The invention will be explained in more detail on the basis of an embodiment shown in the drawing, in which

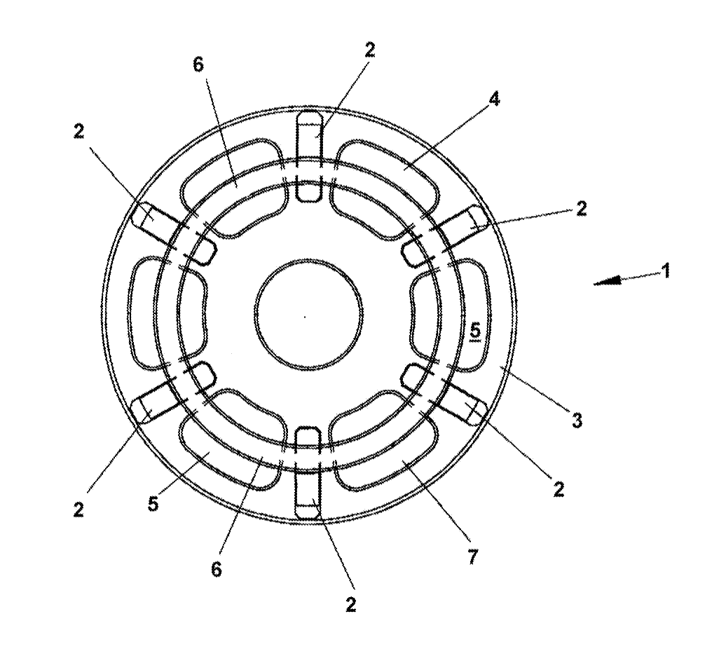

FIG. 1 is a schematic front view of an inventive chuck with a chucked bearing ring.

To explain the invention, FIG. 1 shows only a schematic front view of a chuck 1, which for carrying out the invention may be provided in a manually or power-operated embodiment, because the basic design of the chuck 1 for actuating the jaws can be taken without modifications from the prior art. FIG. 1 shows a chuck body 3, in which a plurality, here six, jaws 2 are radially guided, a pole block 7 having at least one solenoid 4 is provided in the chuck body 3 behind the jaws 2 and according to the illustrated embodiment six solenoids 4 are provided between the travel paths of the jaws 2. According to an example, which is not shown, each magnetic region 5 may comprise regions having different poles by being separated in the center, adjacent regions of adjacent magnetic regions maintaining different polarities. These solenoids 4 define the magnetic regions 5, and adjacent magnetic regions 5 have opposite magnetic polarities. With such a chuck 1, it is possible to place workpieces 6 sensitive to deformation, particularly thin-walled rings such as bearing rings, between the jaws 2 and center the workpiece 6 by closing the jaws 2. After centering the workpiece 6, it is held by the action of the magnet, particularly by the activation of the solenoids 4, this retention of course being assisted by the jaws 2 that do are not however responsible for the bulk of clamping force to prevent deformation of the easily deformed workpieces 6. In addition, the inventive chuck 1 offers the possibility of increasing the field strength of the solenoid 4 in order to compensate for the centrifugal force-induced loss of clamping force of the jaws 2 and/or of increasing the clamping force of the jaws 2 directly. In order to be able to machine the workpiece regions that are in contact with the jaws 2, after machining the two free surfaces of the workpiece 6, it is furthermore provided that these jaws 2 are opened, retracted, or otherwise disengaged from the areas to be machined, and that, if necessary, the field strength of the solenoid 4 is increased, which is then solely responsible for chucking the workpiece 6.

1-11. (canceled)

12. A method of chucking an easily deformed workpiece, the method comprising the steps of:
positioning the workpiece between a plurality of jaws on a face of a chuck rotatable about an axis;
radially engaging the jaws with the workpiece to shift the workpiece to a position centered on the axis; and
magnetically attracting the workpiece and retaining it in the centered position against the chuck face.

13. The method defined in claim 12 wherein the chuck is provided with at least one electromagnet and the workpiece is magnetically attracted against the chuck face by electrically energizing the electromagnet.

14. The method defined in claim 13 wherein before the workpiece is in the centered position the electromagnet is not energized and the workpiece is not attracted against the chuck face, the energization being commenced at the earliest when the workpiece is in the centered position.

15. The method defined in claim 13 wherein the electromagnetic is electrically energerized at a low level to create a weak magnetic field before the workpiece is in the centered position and is electrically energized at a higher level to create a strong magnetic field after the workpiece is in the centered position.

16. The method defined in claim 13, further comprising the steps of:
rotating the chuck and the workpiece after the workpiece is in the centered position.

17. The method defined in claim 16, further comprising the step of:
varying energization of the electromagnet and thereby a strength of a magnetic field produced by the magnet generally proportionately with a rotation speed of the chuck.

18. The method defined in claim 16, further comprising the steps of:
machining at least one surface of the workpiece while it is rotating with the chuck; and thereafter
disengaging the jaws from another surface of the workpiece and machining the other surface.

19. The method defined in claim 18, further comprising the step of
increasing electrical energization of the electromagnet and a field strength thereof after disengaging the jaws from the other surface.

20. A chuck for holding an easily deformed workpiece, chuck comprising:
a chuck body centered on an axis and having an axially directed face;
a plurality of radially displaceable jaws angularly spaced on the face about the axis;
means for radially displacing the jaws into engagement with a workpiece between the jaws and thereby radially shifting the workpiece to a position centered on the axis; and
means including a solenoid in the chuck body behind the jaws for magnetically attracting the workpiece and retaining it in the centered position against the chuck face.

21. The chuck defined in claim 20 wherein the means for radially displacing shifts the jaws out of engagement with the workpiece after the workpiece is in the centered position, the means including the solenoid increasing a field strength of the electromagnet after the workpiece is in the centered position.

22. The chuck defined in claim 20 wherein the solenoid includes a plurality of coils angularly between the jaws, the means including the solenoid energizing the coils so as to form fields of angularly alternating polarity.

23. The chuck defined in claim 22 wherein there is an even number of coils.

24. The chuck defined in claim 23 wherein there are six coils and six jaws.

25. The chuck defined in claim 20 wherein the solenoid includes a plurality of split coils angularly between the jaws, the means including the solenoid oppositely energizing sides of the coils to create opposite polarities.
